(19) United States
(12) Patent Application Publication
(10) Pub. No.: US 2006/0100917 A1
(43) Pub. Date: May 11, 2006

(54) TAKT CALCULATOR FOR USE IN OPERATIONALIZING PROCESS EXCELLENCE

(75) Inventors: Barbara Macy, Charlotte, NC (US); Aline Young, Charlotte, NC (US); Kenneth R. Dafforn, Charlotte, NC (US)

Correspondence Address: MOORE & VAN ALLEN PLLC, P.O. BOX 13706, Research Triangle Park, NC, 27709, US

(73) Assignee: BANK OF AMERICA CORPORATION, Charlotte, NC (US)

(21) Appl. No.: 10/905,254

(22) Filed: Dec. 22, 2004

Related U.S. Application Data
(60) Provisional application No. 60/522,817, filed on Nov. 10, 2004.

(51) Int. Cl. G06F 17/30

(52) U.S. Cl. 705/10

(57) ABSTRACT

Takt calculator for use in operationalizing process excellence. A takt time calculator tool can help facilitate a six sigma and/or lean methodology that can operationalize process excellence. The takt calculator can determine an amount of time needed to produce a unit of output subject to demand in both an “as-is” and a “to-be” process. The takt time can be output via a screen display, writing the takt time to a data store, or a combination of the two. In some embodiments, a production rate can also be calculated and output in a similar fashion. Additionally, unit conversion can be accomplished as necessary to perform the required calculations where units of time are input for the daily time available and the units of output demanded.

### CROSS-REFERENCE TO RELATED APPLICATION

This application claims priority from co-pending provisional patent application Ser. No. 60/522,817 filed Nov. 10, 2004, the entire disclosure of which is incorporated herein by reference.

### CROSS-REFERENCE TO COMPUTER PROGRAM LISTING APPENDIX

A portion of the present disclosure is contained in a computer program listing appendix. The appendix contains an MS-DOS file entitled BCMod.txt created on Dec. 21, 2004, of approximately 16 kilobytes. The contents of this file are incorporated herein by reference. Any references to “the appendix” or the like in this specification refer to this file. The contents of this file are subject to copyright protection. The copyright owner has no objection to the reproduction by anyone of the patent document or the appendix as it appears in the Patent and Trademark Office patent files or records, but does not waive any other copyright rights by virtue of this patent application.

### Background

Understanding how to execute a business process within a company or enterprise in order to maximize revenue, profit, or other metrics, is of enormous importance and has a significant impact on the company's success in the marketplace. Ideally therefore, business processes should be monitored, modeled, and optimized in much the same ways as scientific or manufacturing processes. Thus, the same management tools and methodologies as typically applied to manufacturing processes, for example six sigma and “lean” management techniques, can and should be applied to business processes.

Six sigma is a rigorous and disciplined methodology that uses data and statistical or statistics-like analysis to improve operational performance. The term “sigma” refers a statistical expression of numbers defects per numbers opportunities, with “six sigma” corresponding to 3.4 defects per million. “Lean” is a term used to refer to techniques originally developed in the automobile industry to improve manufacturing performance. Lean and six sigma methodologies can be applied together.

When a business process is being analyzed using either a six sigma or a lean technique (or both) the faster the analysis can be accomplished with accuracy, the sooner the enterprise can reap the benefits. Thus, tools and methods to make the six sigma, lean, or other process being used to improve or operationalize excellence of the business process can be important. Summary

Embodiments of the present invention describe a tool that can help facilitate an expedited six sigma and/or lean methodology. Such a methodology may be referred to herein as “turbolean” and can be used to operationalize business process excellence. The turbolean method includes characterizing current or “as-is” business processes and developing, characterizing, and evaluating “to-be” business processes in a continuous improvement loop. The tool of the present invention can facilitate the evaluation of “takt” time for as-is and to-be processes, where “takt” is a German word for a baton or the like that is used to regulate tempo in music. Thus takt time in the business process sense is related to the rate at which desired units our output from a business process.

In example embodiments of the invention a takt calculator can determine an amount of time needed to produce a unit of output subject to demand in a selected one of a to-be process or an as-is process developed through operationalizing process excellence. The takt calculator receives as input total available work time per day for the selected process and a number of units of output demanded in a pre-selected time period (per day). These inputs are first derived in the course of characterizing the as-is process. Takt time is calculated to further characterize the selected process in order to facilitate further operationalizing of process excellence. The takt time can then be output via a screen display, writing the takt time to a data store, or a combination of the two. In some embodiments, a production rate can also be calculated and output in a similar fashion. Additionally, unit conversion can be accomplished as necessary to perform the required calculations where units of time are input for the daily time available and the units of output demanded.

In some embodiments, the invention is implemented via either a stand-alone instruction execution platform or such a platform interconnected with other platforms or data stores by a network, such as a corporate intranet, a local area network, or the Internet. A computer program product or computer program products contain computer programs with various instructions to cause the hardware to carry out, at least in part, the methods and processes of the invention. Data stores can include inputs developed through team activities, as well as takt and production outputs for use in further efforts at operationalizing process excellence relative to the business process or processes at issue.

### BRIEF DESCRIPTION OF THE DRAWINGS

FIG. 1 is a block diagram of an overall system that promotes business excellence, in part through operationalizing process excellence.

FIG. 2 is a flowchart that illustrates a portion of a method of using lean tools according to embodiments of the invention to operationalize process excellence.

FIG. 3 is a screenshot of an input/output screen for the takt time calculator according to example embodiments of the invention.

FIG. 4 is a flowchart that illustrates the operation of the takt time calculator according to example embodiments of the invention.

FIG. 5 is a source code listing for an example takt time calculator according to an embodiment of the invention. FIG. 5 is presented in two parts as FIG. 5A and 5B.

FIG. 6 is a system block diagram according to example embodiments of the invention.

### DETAILED DESCRIPTION

The present invention will now be described in terms of specific, example embodiments. It is to be understood that the invention is not limited to the example embodiments disclosed. It should also be understood that not every feature of the systems and methods described is necessary to implement the invention as claimed in any particular one of the appended claims. Various elements, steps, processes, and features of various embodiments of systems, apparatus, and processes are described in order to fully enable the invention. It should also be understood that throughout this disclosure, where a process or method is shown or described, the steps of the method may be performed in any order or simultaneously, unless it is clear from the context that one step depends on another being performed first. Also, time lags between steps can vary.

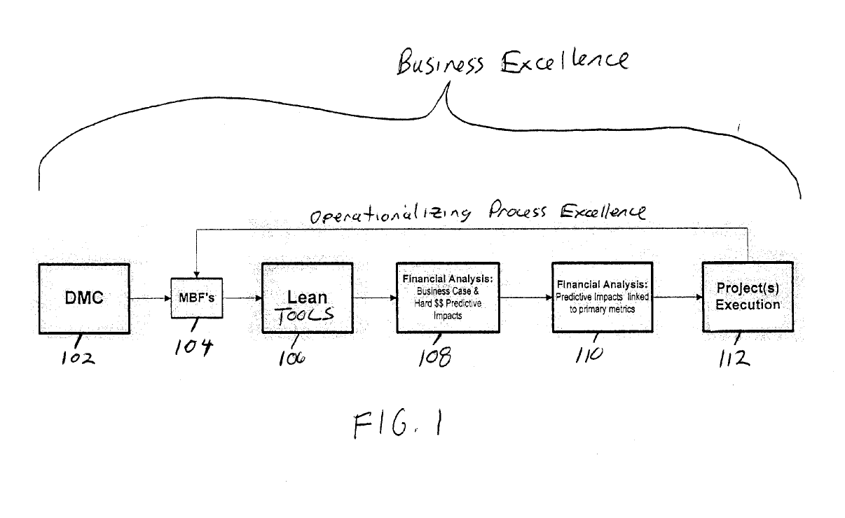

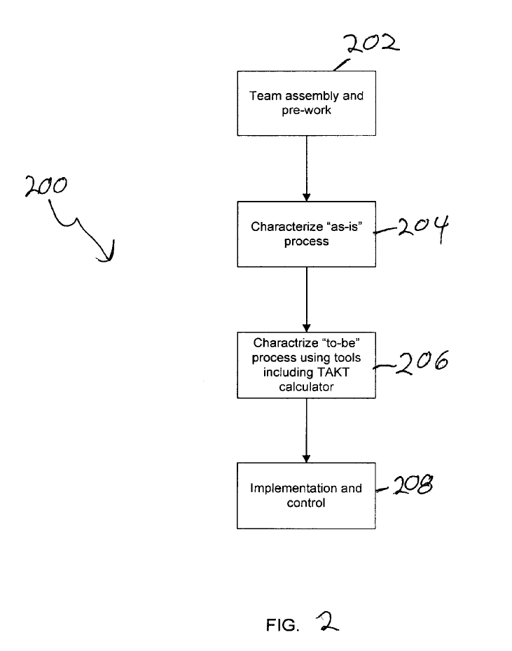

FIG. 1 illustrates the operating environment of the invention as a system of related activities represented by system blocks. These activities can be carried out to some extent in parallel and there may be overlap between the activities. The system can be used to enable or operationalize process excellence and may include varying numbers of tools as a part of the process. Portions of the process may be referred to herein as “turbolean.” Turbolean can be a 30 to 90 day execution methodology that melds process excellence with six sigma tools and lean tools (which together may be referred to herein as “lean” tools), and may include activity-based financial tools along with an operational efficiency model, to create a continuous improvement productivity loop. The example system of FIG. 1 includes define, measure, and control (DMC) activities 102, and management by fact activities (MBF's) 104.

In block 106 of FIG. 1, lean tools, and possibly other tools are used to produce financial analysis including a business case and hard-cost-related, predictive impacts, as shown at block 108. Subsequently, a financial analysis that includes predictive impacts linked to primary metrics is produced at block 110. Project execution 112 can then be undertaken, which is managed by fact at block 104. This implementation and control can produce a feedback loop that operationalizes process excellence, within an overall system of business excellence system.

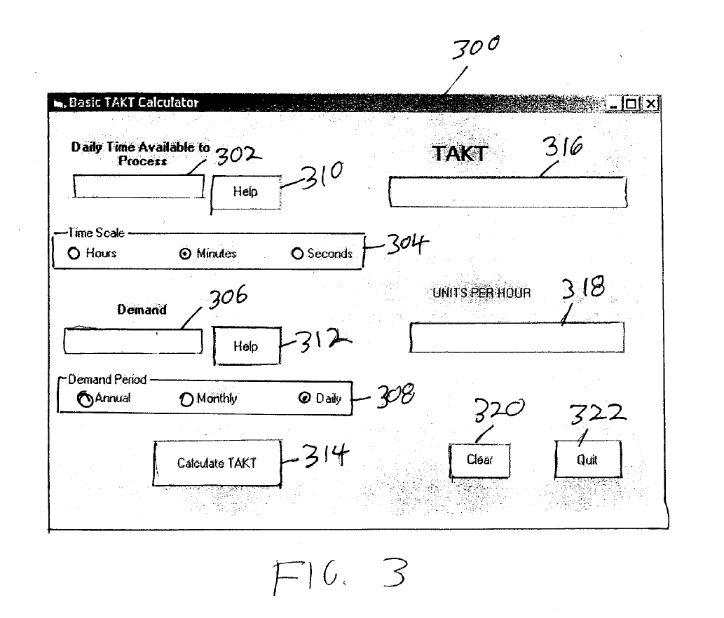

FIG. 2 describes how the tools used in the system of FIG. 1 are applied to produce the financial analysis and implement process improvement. As opposed to the system view of FIG. 1, FIG. 2 is a process view presented in flowchart form, as a series of process blocks. Process 200 of FIG. 2 includes team assembly and pre-work as shown at block 202. Pre-work sessions in some embodiments are those in which products' or services' evolution can be examined and opportunities to reduce completion time, improve delivery time to customers and reduce overall costs can be identified. Tools can be used to characterize an end-to-end flow of the product through the business process. These tools can include kick-off information meeting materials and team member lists. A kick-off meeting can provide an open forum to address questions to the members with respect to the process early so the members are more productive during the team sessions. A performance plan can be developed that incorporates current and future processes and a recommended timeline for tracking the project. The tools used early in pre-work call sessions can include an assessment tool and a performance plan tool, for example, as well as Hoshin planning or other closed-loop performance plan tools to provide a baseline and a progression check of metrics for initiatives. A lean work plan and the member contact list can also be used in the pre-work sessions to document the project tasks, the lean team member(s) assigned a particular task, and task start and completion dates.

In the example of FIG. 2, the as-is process can be characterized at block 204 by determining the impact of changes on the process and on employee views through developing an as-is process map, including a time vs. waste view of the business process. Additional tools used can include a management plan, skills matrix, a voice-of-the-associate (VOA) or employee opinion survey, and a work plan. The work plan can help identify the stakeholders, their reaction to the changes and potential risks. The skills matrix identifies the strengths and weaknesses of team members by ascertaining the gaps to skills needed to complete the project.

A multi-generational plan can be established. The first generation of the plan can set out tasks for vision, process generations, technologies, scope, governance and metrics for tracking project success. The first generation plan can also set out a generation task timeline. To determine the voice-of-the associate, a survey can be prepared to determine what works, what doesn't work, what should be changed, and a positive and a negative that would impact the product or service or the use of it.

Process maps can be created to assist in characterizing the as-is process. Data can be collected from on-site interviews of the associates (employees) and directly used to build an overall as-is process map and other types of process maps. A spaghetti map can also be constructed that illustrates the environment of the as-is process. Additionally, causes and effects can be analyzed and described as part of the as-is process using such tools as a cause-and-effect fishbone diagram and a cause-and-effect matrix built from the fishbone. Additionally, waste can be described and characterized, and quantified based on observed timings and Muda costing.

An additional tool that can be used early in team sessions at block 204 of FIG. 2 is the “cost-of-poor-process-opportunity” (COPPO) tool, which captures and identifies the cost per process step. In example embodiments, this tool can be implemented with a Microsoft Excel™ spreadsheet running a visual basic macro. The same type of spreadsheet can be used later to identify future COPPO or the COPPO in the “to-be” process. Source code for visual basic macros to provide a COPPO spreadsheet for both the as-is and to-be processes in tabs (along with other tools) is contained in the appendix.

Later, possibly in team sessions, the to-be process can be characterized as shown at block 206 of FIG. 2. Various tools such as a project prioritization by risk/reward and a baseline tree metric can be used along with process flows, some of which are updated from the analysis of the as-is process. For example, the VOA can be used, as well as an activity of the product analysis, an activity of the associate analysis, and an activity of the equipment analysis. Such analysis tools can include a process flows and time value maps. The activity of the equipment (AOE) analysis can include determining operating equipment efficiency and developing an associated efficiency log, and an AOE spaghetti map. One tool that can be used to determine a future or to-be state is an analysis to identify, and then convert or eliminate (ICE) waste. Sources of waste are analyzed, and financial analysis can be performed. A takt time calculator, which can also be referred to as a takt-o-meter or takt-o-meter tool, can be used to determine the pace of production needed to produce a unit to meet customer demand requirements at a level necessary to drive the to-be state or optimize the as-is state. Details of an example embodiment of the takt-o-meter are discussed below with respect to the remaining figures.

In the operating environment of the invention, as described by FIGS. 1 and 2, a new process design and product flow can be delineated, along with any exception flows necessitated. Standard work is described so that an associate can be trained. Strategies and assessments can be completed, and can include monument identification, and a so-called “5S” assessment, which focuses on workplace layout and cleanliness. In addition, as part of the to-be process characterization of FIG. 2, an operating efficiency analysis is done through an operating efficiency model providing complexity and skill level scenarios for various staffing and inventory levels against a primary metric that is variable by engagement. One example of the operating efficiency model is implemented via a spreadsheet running a visual basic script. Example visual basic source code is included in the appendix.

Material inputs for the business process can be identified along with an internal replenishment plan or “Kanban” strategy. Perishable supplies can also be described and supported with Kanban calculations. Cost analysis can be performed for the to-be process, and a business case proof of concept tool can be used to identify cost-per-step in the to-be process compared to costs in the former as-is process, the savings opportunity, and the initiatives needed to capture the opportunity in the new process. Another tool, a critical-to-business results analysis can be used to compare the business value determined for each initiative coming out of the to-be process against its ease of implementation. The business case proof of concept tool can be implemented as a spreadsheet running a visual basic script. An example visual basic source code listing for a multi-tabbed spreadsheet file that includes as-is and to-be COPPO tool worksheets as well as an example business case proof of concept tool worksheet. An operational risk assessment can be done to assess potential risk for the proposed initiatives.

As shown at block 208 of FIG. 2, a deployment/implementation and control plan can be created and executed after the as-is and to-be processes or “states” have been characterized and analyzed. Final metrics are defined and linked to the initiatives being piloted. A final operating efficiency matrix can also be used to model pilot results. A plan for visually displaying and updating these metrics is also put in place. New roles and responsibilities are defined, standard work definitions are developed and a scheduling system can be refined and/or created. A final or additional to-be takt and staffing calculation can be performed and institutionalized. Typically, ongoing training and support plans are also put in place. As part of the control plan, the multi-generational plan previously discussed can be updated or created. In addition a “Kaizen” strategy, audit routine, and workflow policies and procedures can be created and implemented. After the above is completed the new process is fully implemented and results including lessons learned are captured. A plan can then be put in place to transition to a new process, possibly including new or newly certified personnel.

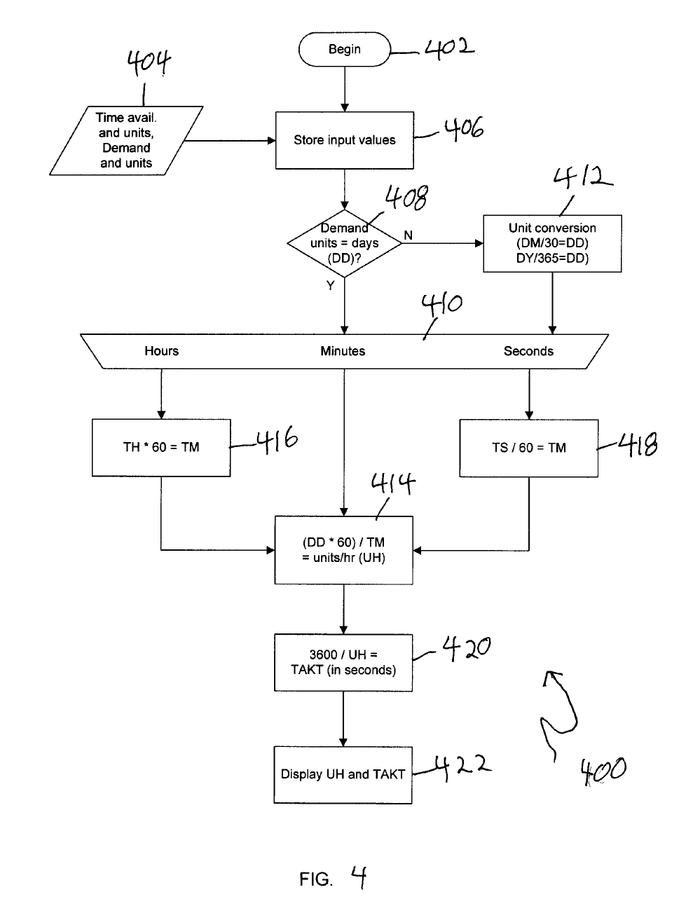

FIG. 3 is an example screen shot of a user screen, 300, for a software implementation of the takt calculator discussed above according to example embodiment of the invention. In this particular example, a daily time available for the business process in question is input in box 302. A time scale for this daily time is selected using radio buttons 304. A demand in terms of number of units of output is input at box 306. A time scale for the demand, which might be termed the demand period, is input using radio buttons 308. Note that the time scale for radio buttons 304 is either hours, minutes, or seconds. The time scale for radio buttons 308 is either annual, monthly, or daily. Other time scale options can be made available as needed for the types of processes being analyzed. Context sensitive help is provided by clicking button 310 in the case of the daily time available, and clicking button 312 in the case of the demand.

The takt calculator which maintains screen 300 will perform calculations using the input supplied when button 314 is pressed or clicked. Once the calculations are complete, in this example embodiment, the takt is displayed in display box 316. The number of units per hour which will be required based on the calculated takt and the inputs is displayed in display box 318. A clear button, 320, is provided to clear all input and output fields and set the calculator up for another calculation. In addition, quit button 322 exits the calculator application and returns to the operating system. In this example embodiment, the calculator is implemented in basic running within the Microsoft Windows™ operating system, as evidenced by the standard Windows frame controls.

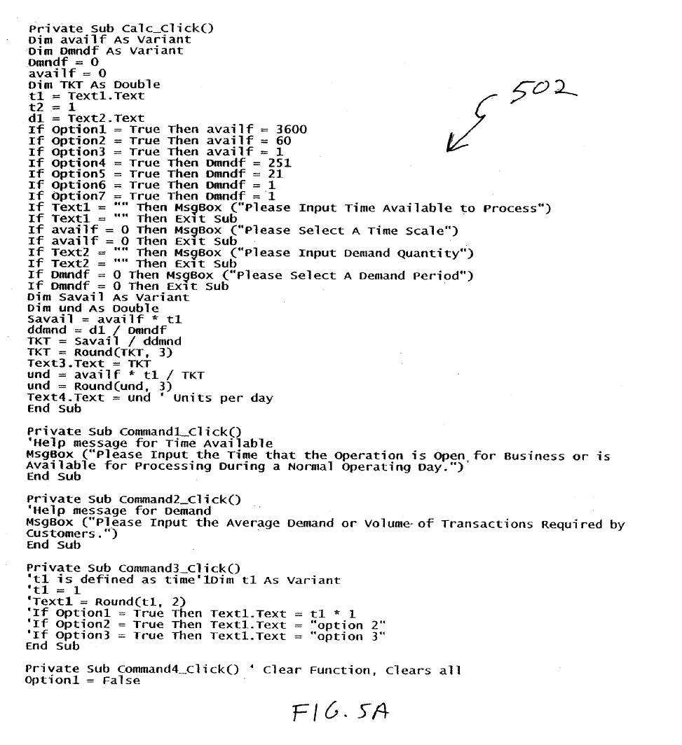

FIG. 4 illustrates an example process, 400, for a takt calculator application according to an example embodiment of the invention. FIG. 4 is a flowchart illustration. As is typical with a flowchart illustrations, sub-processes, elements, or steps are illustrated as a series of process blocks. Process 400 begins at block 402 when a user presses a calculate button. Inputs 404 are stored at block 406. These inputs, as previously discussed, include a time available, a demand, and possibly units for each. It can be assumed for purposes of this example embodiment that calculations are to be performed with time available expressed in minutes (TM) and with demand expressed in demand for units per day (DD). It should be noted that there are numerous ways to architect an application of this type, and units can be handled in many different ways. Returning to the example of FIG. 4, if the demand units are in days at decision block 408, processing proceeds to tri-partite decision block 410. Otherwise, a unit conversion for the demand is carried out at block 412. If the demand is expressed in units per month, that value is divided by 30 to obtain demand in terms of units per day. Likewise, if the demand is expressed on an annual basis, that value is divided by 365 to obtain units per day.

The units of the time available input are handled at block 410. If the units are already in minutes, processing proceeds to block 414 for the final calculations. If time available is expressed as time available in hours (TH), then this value is multiplied by 60 at block 416. If the time available is expressed in seconds (TS), then that value is divided by 60 at block 418 to arrive at time available expressed in minutes (TM).

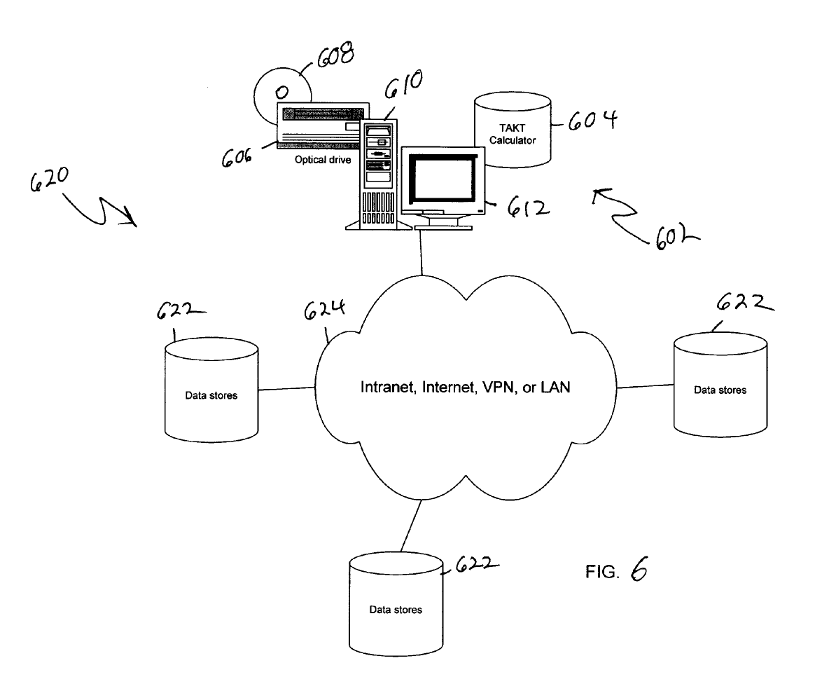

In any of the above cases, once the unit conversion is accomplished in the process of FIG. 4, units per hour (UH) are calculated at block 414. In this example, demand per day is multiplied by 60, with the result divided by time available in minutes (TM). Takt is often expressed in seconds. Thus, 3600 is divided by the number of units per hour at block 420 to obtain takt. Finally, the units per hour and the takt are displayed at block 422. As previously discussed, and as will be shown further with respect to FIG. 6, the results of the calculations performed by process 400 of FIG. 4 can also be saved in a media or to a data store.

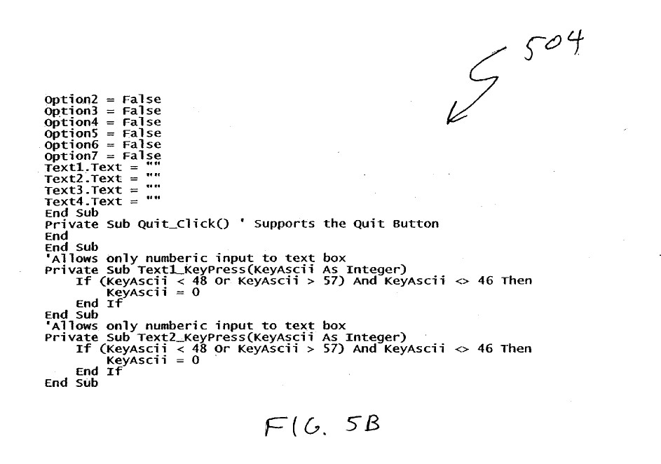

FIG. 5 is a source code listing for the example takt calculator, the input screen generated by which was illustrated in FIG. 3 and discussed with respect thereto. It should be noted that FIG. 4 is conceptual in nature, and the embodiment discussed with respect to FIG. 4 may not necessarily match all aspects of the embodiment shown in FIGS. 3 and 5. FIG. 5 is divided into FIGS. 5A and 5B for convenience. A first portion, 502, of the source code listing is illustrated in FIG. 5A. A second portion, 504, of the source code listing as illustrated in FIG. 5B.

FIG. 6 illustrates a typical operating environment for embodiments of the present invention. FIG. 6 actually illustrates two alternative embodiments of a system implementing the invention. System 602 can be a workstation or personal computer. System 602 can be operated in a “stand-alone” mode. The system includes a fixed storage medium, illustrated graphically at 604, for storing programs and/or macros which enable the use of an embodiment of the invention. In a stand-alone implementation of the invention, fixed storage 604 can also include saved output data, such as takt times, and saved input data obtained from characterizing a business process being analyzed. In this particular example, an optical drive, 606, is connected to the computing platform for loading the appropriate computer program product into system 602 from an optical disk, 608. The computer program product includes a computer program or programs with instructions or code for carrying out the methods of the invention. Instruction execution platform 610 of FIG. 6 can execute the appropriate instructions and display appropriate screens on display device 612. These screens can include the user input and output screen previously discussed.

FIG. 6 also illustrates another embodiment of the invention in which case the system 620, which is implementing the invention includes a connection to data stores 622, from which data obtained from characterizing a business process being analyzed can be read, and to which output data such as takt times and the like can be stored. The connection to the data stores or appropriate databases can be formed in part by network 624, which can be an intranet, virtual private network (VPN) connection, local area network (LAN) connection, or any other type of network resources, including the Internet.

A computer program which implements all or parts of the invention through the use of systems like those illustrated in FIG. 6 can take the form of a computer program product residing on a computer usable or computer readable storage medium. Such a computer program can be an entire application to perform all of the tasks necessary to carry out the invention, or it can be a macro or plug-in which works with an existing general purpose application such as a spreadsheet or database program. Note that the “medium” may also be a stream of information being retrieved when a processing platform or execution system downloads the computer program instructions through the Internet or any other type of network. Computer program instructions which implement the invention can reside on or in any medium that can contain, store, communicate, propagate or transport the program for use by or in connection with any instruction execution system, apparatus, or device. Such a medium may be, for example, but is not limited to, an electronic, magnetic, optical, electromagnetic, or semiconductor system, apparatus, device, or network. Note that the computer usable or computer readable medium could even be paper or another suitable medium upon which the program is printed, as the program can then be electronically captured from the paper and then compiled, interpreted, or otherwise processed in a suitable manner.

Specific embodiments of an invention are described herein. One of ordinary skill in the computing and process management arts will recognize that the invention can be applied in other environments and in other ways. It should also be understood that an implementation of the invention can include features and elements or steps in addition to those described and claimed herein. Thus, the following claims are not intended to limit the scope of the invention to the specific embodiments described herein.

What is claimed is:

1. A method of determining an amount of time needed to produce a unit of output subject to demand in a process selected from a to-be and an as-is process developed through operationalizing process excellence, the method comprising:
receiving as input, a daily time available for the selected process and a number of units of output demanded in a pre-selected time period, the daily time available and the number of units of output having been derived in the course of characterizing the selected process;
calculating a takt time that further characterizes the selected process in order to facilitate further operationalizing of process excellence; and
outputting the takt time.

2. The method of claim 1 further comprising:
calculating a production rate that further characterizes the selected process; and
outputting the production rate.

3. The method of claim 2 wherein the input further includes units of time corresponding to the daily time available and the units of output demanded, and further comprising performing unit conversion when needed on the daily time available and the pre-selected time period.

4. The method of claim 2 wherein:
the outputting of the takt time further comprises displaying the takt time; and
the outputting of the production rate further comprises displaying the production rate.

5. The method of claim 4 wherein:
the outputting of the takt time further comprises sending the takt time to a data store; and
the outputting of the production rate further comprises sending the production rate to a data store.

6. The method of claim 3 wherein:
the outputting of the takt time further comprises displaying the takt time; and
the outputting of the production rate further comprises displaying the production rate.

7. The method of claim 6 wherein:
the outputting of the takt time further comprises sending the takt time to a data store; and
the outputting of the production rate further comprises sending the production rate to a data store.

8. A computer program product for determining an amount of time needed to produce a unit of output subject to demand in a process selected from an as-is and a to-be process developed through operationalizing process excellence, the computer program product including computer program code comprising:
instructions for receiving as input, a daily time available for the selected process and a number of units of output demanded in a pre-selected time period, the daily time available and the number of units of output having been derived in the course of characterizing the selected process;
instructions for calculating a takt time that further characterizes the selected process in order to facilitate further operationalizing of process excellence; and
instructions for outputting the takt time.

9. The computer program product of claim 8 wherein the computer program further comprises:
instructions for calculating a production rate that further characterizes the selected process; and
instructions for outputting the production rate.

10. The computer program product of claim 9 wherein the input further includes units of time corresponding to the daily time available and the units of output demanded, and wherein the computer program further comprises instructions for performing unit conversion on the daily time available and the pre-selected time period.

11. The computer program product of claim 9 wherein the computer program further comprises instructions for displaying the takt time and the production rate.

12. The computer program product of claim 11 wherein the computer program further comprises instructions for sending the takt time and the production rate to a data store.

13. The computer program product of claim 10 wherein the computer program further comprises instructions for displaying the takt time and the production rate.

14. The computer program product of claim 13 wherein the computer program further comprises instructions for sending the takt time and the production rate to a data store.

15. Apparatus for determining an amount of time needed to produce a unit of output subject to demand in a process selected from an as-is and a to-be process developed through operationalizing process excellence, the apparatus comprising:
means for receiving as input, a daily time available for the selected process and a number of units of output demanded in a pre-selected time period, the daily time available and the number of units of output having been derived in the course of characterizing the selected process;
means for calculating a takt time that further characterizes the selected process in order to facilitate further operationalizing of process excellence; and
means for displaying the takt time.

16. The apparatus of claim 15 further comprising:
means for calculating a production rate that further characterizes the selected process; and
means for displaying the production rate.

17. The apparatus of claim 16 wherein the input further includes units of time corresponding to the daily time available and the units of output demanded, and further comprising means for performing unit conversion on the daily time available and the pre-selected time period.

18. The apparatus of claim 16 further comprising means for sending the takt time and the production rate to a data store.

19. The apparatus claim 17 further comprising means for sending the takt time and the production rate to a data store.

20. A system for determining an amount of time needed to produce a unit of output subject to demand in a process selected from an as-is and a to-be process developed through operationalizing process excellence, the system comprising
an instruction execution platform operable to receive a daily time available for the process and a number of units of output demanded in a pre-selected time period, the daily time available and the number of units of output having been derived in the course of characterizing the selected process and to calculate a takt time that further characterizes the selected process in order to facilitate further operationalizing of process excellence; and
a data store operatively connected to the instruction execution system to supply the daily time available and the number of units of output demanded and to store the takt time.

21. The system of claim 20 wherein the instruction execution platform is further operable to calculate a production rate that further characterizes the selected process and the data store is further operable to store the production rate.

22. The system of claim 20 wherein the instruction execution system is further operable to provide unit conversion for units of time corresponding to the daily time available and the units of output demanded.

23. The system of claim 21 wherein the instruction execution system is further operable to provide unit conversion for units of time corresponding to the daily time available and the units of output demanded.
